(19) United States
(12) Patent Application Publication
(10) Pub. No.: US 2021/0008434 A1
(43) Pub. Date: Jan. 14, 2021

(54) Personal Electronic Sports Scoring Device with Graphical Display

(71) Applicant: John W. Swafford, JR., Palatine, IL (US)

(72) Inventor: John W. Swafford, JR., Palatine, IL (US)

(21) Appl. No.: 16/925,654

(22) Filed: Jul. 10, 2020

Related U.S. Application Data
(60) Provisional application No. 62/872,340, filed on Jul. 10, 2019.

(51) Int. Cl. A63B 71/06; G06F 3/02; G06F 3/041; H04R 1/02; G06F 3/16; H04R 1/08; G09G 5/36

(52) U.S. Cl. CPC A63B 71/0669; G09G 2354/00; G06F 3/02; G06F 3/041; H04R 1/028; G06F 3/165; H04R 1/08; G09G 5/36; A63B 2071/0694; A63B 2071/0663; A63B 2225/50; A63B 2071/0625; A63B 2220/808; A63B 2071/0655; A63B 71/0622

(57) ABSTRACT

A battery operated electronic device worn by an individual while participating in a sport. A graphical display depicts aspects of the sport venue and buttons on the device allow entry of data required to keep score and determine other important elements of the game as it progresses. Although it could be used for many sports including, but not limited to, pickleball, tennis, golf, softball, etc., an exemplary embodiment is directed to the sport of pickleball.

### CROSS-REFERENCE TO RELATED APPLICATION

The application is a non-provisional application of and claims benefit to U.S. Provisional Application No. 62/872,340 filed Jul. 10, 2019, which is incorporated herein by reference.

### FIELD

The exemplary embodiments relate generally to personal electronic scoring systems for use with athletic games, such as, pickleball.

### BACKGROUND

The game of pickleball is a sport played indoors or outdoors with a solid paddle and a perforated hollow plastic ball. It is played on a court similar to but smaller than a tennis court. Various rules apply to the progression of play of the game as defined by the United States of America Pickleball Association or USAPA.

At the end of 2019, it was estimated that over three million people in the United States were pickleball players. It is further estimated that of those who play at least eight times per year, 64% are aged 55 and over.

The typical game is played by two teams of two players as ‘doubles,’ although two players can play ‘singles.’ The playing court is generally divided into quadrants each generally occupied by a player. Further, two quadrants are on either side of a net which bisects the court and over which the ball must travel during play.

One of the players is designated as the server of the ball at the beginning of the game and puts the ball into play by hitting it over the net to the opposite cross-court quadrant. As the game progresses, only the serving team may score points. As faults occur, the server of the ball may change the quadrant on his side of the court from which he serves or the serving team may change, called a ‘side-out.’ In addition, a general pickleball doubles strategy is that the receiver of the serve should stand at the base-line of his quadrant of the court while his partner should be standing nearer the net at a line parallel to the net bounding an area known as the ‘non-volley’ zone in that player's quadrant. Both players of the serving team generally stand at their baseline.

These elements present the daunting task of keeping track of which team is to serve, which player on the team is to serve, from which court quadrant he or she is to serve from, and where the receiving team players should be standing. After a heated and extended point is played, it is easy for players to lose track of the score, the correct server, and player positions.

There are known manual and electronic scoring devices in the prior art. Some are operated by a referee who can cause the score to be displayed on a large screen. Some are personal and worn by the players who can simply increment or decrement the team scores. Others can provide scoring but are directed primarily toward the fitness including steps taken, duration of game, heart rate, etc. But none of the existing devices manage the scoring, serving team/player, and player positions on the court. Nor do they do so in a graphical manner that is easy to see at a glance while playing the game. Most known devices are updated by indicating which team scored a point, but since only the serving team can make a point, a player must also know which team served the ball before the fault occurred, making it more difficult to quickly determine if, or to which team the point should be awarded to.

The invention overcomes these and other known problems with existing scoring devices and does so by keeping score and tracking the correct server and the player positions as the game is played.

### SUMMARY OF THE INVENTION

Aspects of the invention relate to systems and associated methodologies to score and track the correct server and the player positions as the pickleball game is played.

In a representative embodiment of the invention, for example, a housing containing electronics with a microcontroller and graphical display worn on the wrist of the player, or on a lanyard, with a limited number of push buttons to allow input of data and display game status for easy reference by the player. A touchscreen may be implemented over the display screen for game setup, settings, options, etc. In the case of pickleball, a graphical representation of the playing court is presented on the display, the correct position of each player is shown on the court, as is the current server and each team's score. During game play, only one or two buttons are required to manage and display all information correctly. If two buttons are utilized, one button indicates a fault was committed by a first team, and another button indicates a fault was committed by a second team. If one button is utilized, a single press indicates a fault was committed by a first team, and a double press indicates a fault was committed by a second team.

In an exemplary aspect, it is not necessary to have a button to change the score for each team, because based on which team committed the fault, the device knows which team was serving and only the serving team can score a point. A fault by the serving team results in a change of the player serving or the team serving (side-out).

In one embodiment, the software algorithm and programming run by the internal microprocessor automatically manage the scoring, server position, and recommended player positions according to the rules of the game. When the conditions of winning the game are met, it indicates the winning team on the display. A microphone may allow recording of the name of each player at the beginning of a game. During play, a digitized voice may announce the score and which player is to serve the ball.

### BRIEF DESCRIPTION OF THE DRAWINGS

A more complete understanding of the exemplary embodiments of the present invention and the advantages thereof may be acquired by referring to the following description in consideration of the accompanying figures, in which the same reference numbers are used to designate the same or similar features, and wherein:

FIG. 1 is an exploded view of an exemplary embodiment of the invention.

FIG. 2 is an exemplary embodiment of FIG. 1 with a hook-and-loop type wrist-band.

FIG. 3 is an exemplary embodiment of FIG. 1 with water resistant buttons and features.

FIG. 4 is an exploded view of an alternative exemplary embodiment of the invention.

FIG. 5 is an exemplary embodiment of FIG. 4 with a wrist-band.

FIG. 6 is a simplified operational flowchart for a pickleball game.

FIG. 7 are representative screen displays at various points of operation of the invention.

The Figures should be understood to present an illustration of the invention and principles involved. Simplified systems and process flows are depicted, and some components may be distorted/enlarged relative to others, in order to facilitate explanation and understanding. As is readily apparent to one of skill in the art having knowledge of the present disclosure, the processes and associated equipment for scoring the pickleball game, according to various other embodiments of the invention, will have configurations and components determined, in part, by their specific use.

### DESCRIPTION OF THE EMBODIMENTS

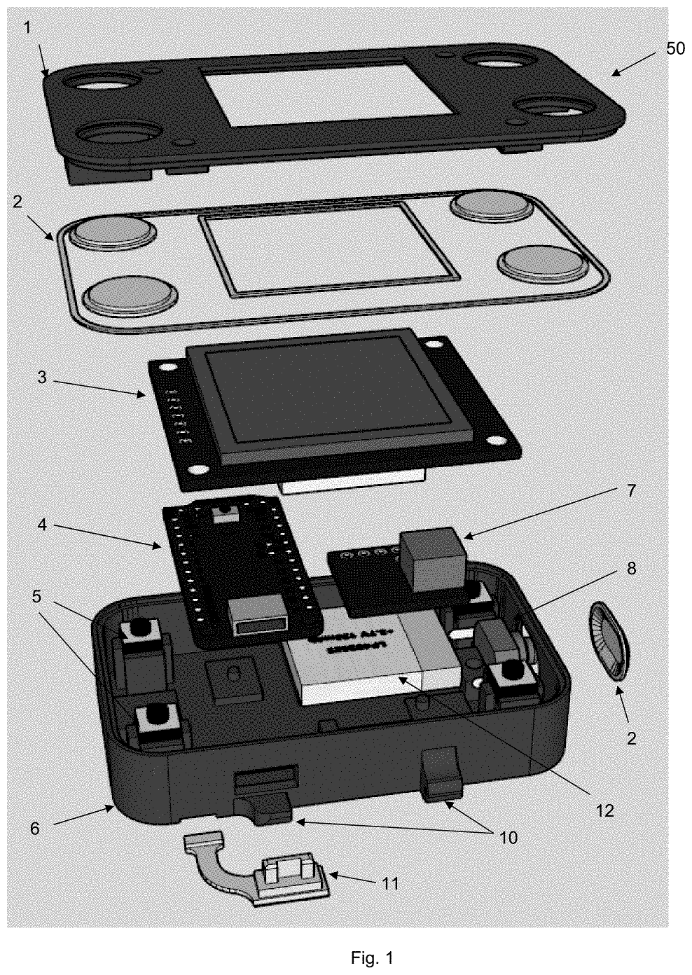

Referring to FIG. 1, there is shown an exemplary embodiment of a personal electronic sports scoring device 50 with graphical display of the invention and includes a housing that comprises a cover 1 and a base housing 6 with flexible sealing gasket 2. The cover 1, base housing 6 and gasket 2 when assembled form a sealed housing in which other components of the scoring device are contained. Also included to seal the housing is a removable cover 11 to plug an opening for a USB port. The removable cover may be attached to the base housing 6.

A display module 3 is operably connected to microprocessor assembly 4 which also comprises a USB port for both charging and software changes. A rechargeable battery 12 is charged by a charging circuit 7 and is also connected to microprocessor assembly 4. A power switch 8 engages or disengages the battery power from the circuit and may be activated by a slide-switch, button press or voice command. One or more switches 5 connect to microprocessor assembly 4 to provide user input for the purpose of controlling the internal software application. Attachment points 10 may be provided for engaging a watch band to the housing so the scoring device may be worn on a user's wrist. The housing may also have a small built-in ring to allow connection of a lanyard for wearing the device around the neck.

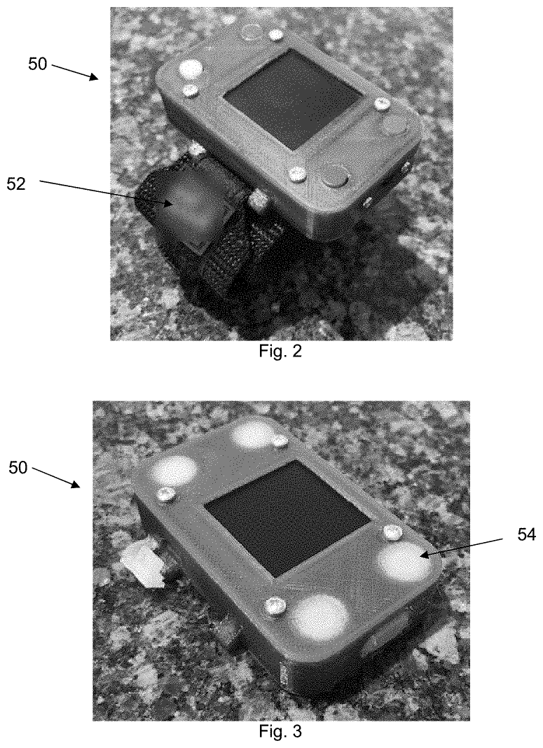

Referring to FIG. 2, the sports scoring device 50 may be attached to a hook-and-loop type wrist-band 52. The scoring device may be attached any other types of bands that could be worn around a player's wrist. Alternatively, the scoring device 50 may be attached to a lanyard or similar type of rope or chain to allow the device to be worn around the player's neck.

Referring to FIG. 3, the sports scoring device 50 may define a top cover 1 that includes water resistant buttons 54 used to score the game.

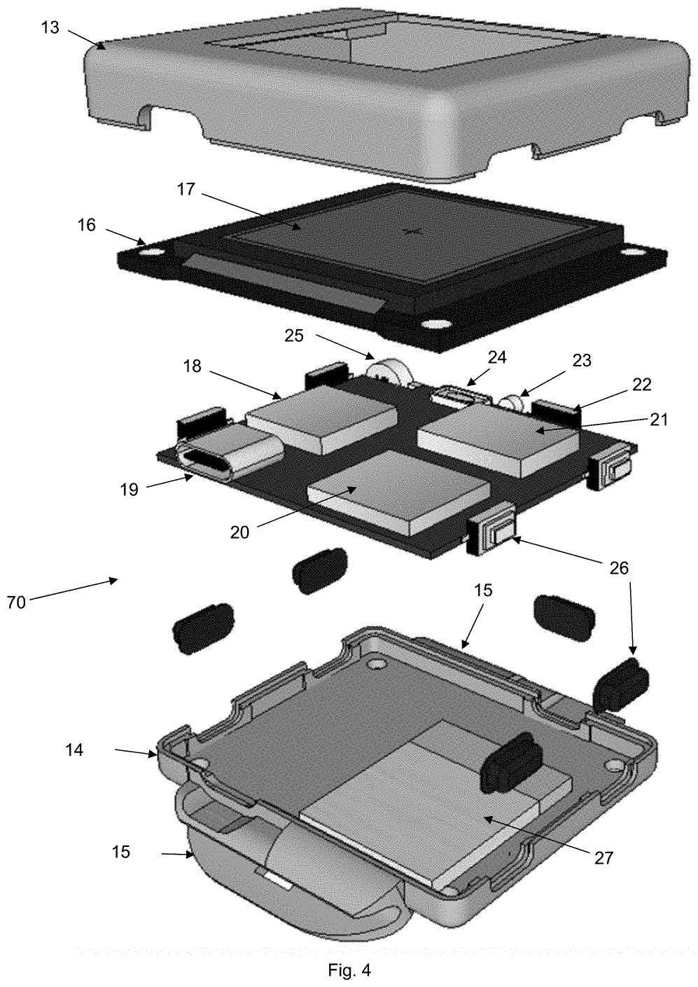

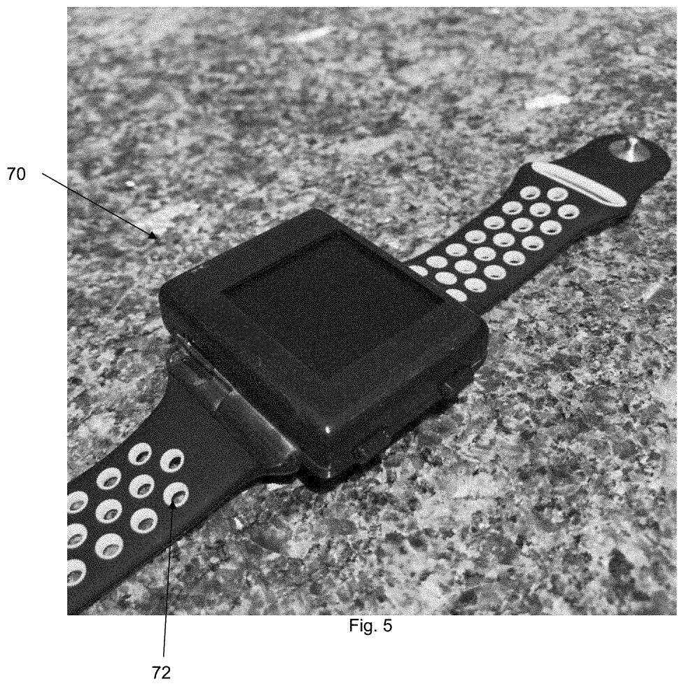

Referring to FIG. 4, there is shown an alternative exemplary aspect of a personal electronic sports scoring device 70 with graphical display and includes a housing that comprises a cover 13 and a base housing 14 and may include flexible sealing gasket parts (not shown). The cover 13, base housing 14 and gasket when assembled form a sealed housing in which other components of the scoring device 70 are contained.

A display module 16 is operably connected to microprocessor assembly 18 which also comprises a USB port 19 for both charging and software changes. A rechargeable battery 27 is charged by a charging circuit 21 and is also connected to microprocessor assembly 18. Power switch 22 engages or disengages the battery power from the circuit and may be activated by a slide switch, button press or voice command. Switches and buttons 26 connect to microprocessor assembly 18 to provide user input for the purpose of controlling the internal software application. Attachment points 15 may be provided for engaging a watch band to the housing so it may be worn on a user's wrist. The housing may also have a small built-in ring to allow connection of a lanyard for wearing the device around the neck (not shown).

A microphone 23 and speaker 24 may be connected to microprocessor for the recording and playback of player names or announcement of the current score or other annunciations. A touchscreen 17 may be incorporated over the display to allow faster and more intuitive entry of game setup or options. Wireless communication circuitry 20 connects to microprocessor assembly 18 for communication to other players wearing other instances of this invention or to remote devices for large screen viewing of the game data or gathering of statistical data. A haptic feedback (vibration) device 25 provides positive feedback of a button press even if the wearer is not looking at the display screen.

Referring to FIG. 5, the sports scoring device 70 may be attached to a watch or wrist-band 72. The scoring device 70 may be attached any other types of bands that could be worn around a player's wrist. Alternatively, the scoring device 70 may be attached to a lanyard or similar type of rope or chain to allow the device to be worn around the player's neck.

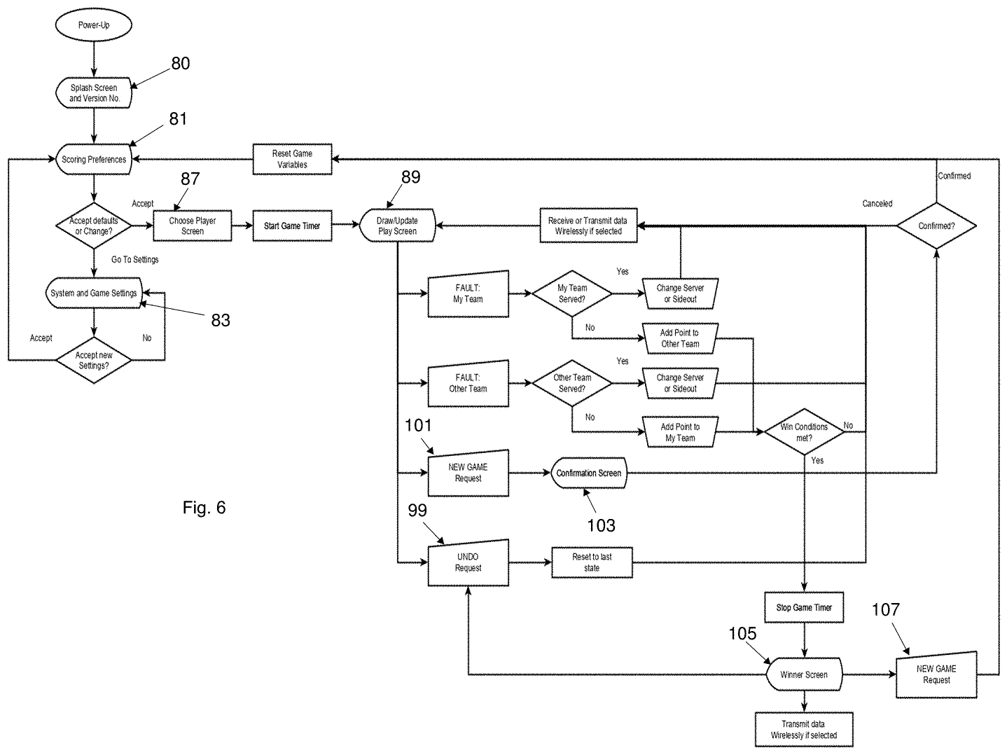

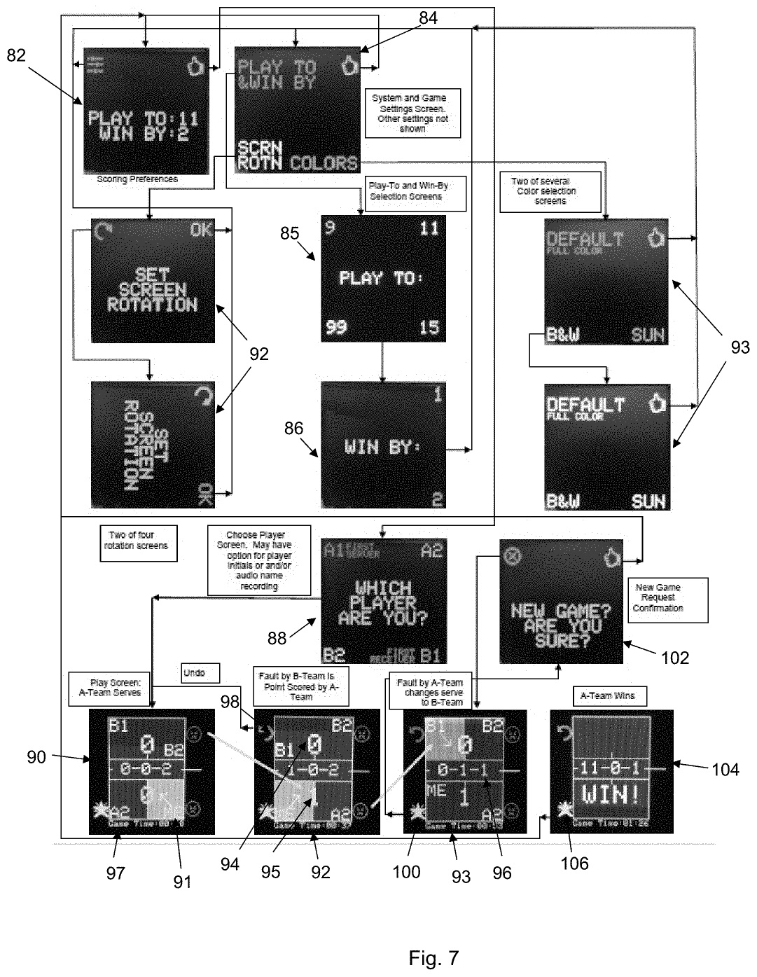

Referring to FIG. 6 an operational flowchart for a pickleball game is provided. Referring to FIG. 7, representative screen displays at various points of operation of the scoring device are depicted. As shown and illustrated by FIGS. 6 and 7, and also referring to FIG. 5, in one exemplary embodiment of the scoring device 70, a substantially rectangular or square display screen 17 has a plurality of push-buttons 26 positioned along at least one side of the housing 14, preferably near a corner of the display screen. The buttons 26 may function as defined by the information on the display screen. For example, during one mode of operation of the scoring device a button may provide a single defined function and in another mode of operation it may have another function.

As depicted by FIGS. 6 and 7, on power-up, the scoring device 70 may display a splash screen 80 for a short period and then offer a series of minimal setup options required to accurately present and track the score and player positions. Default values are initially presented on a Scoring Preferences screen 81 and 82 and can be accepted or changed by electing a System and Game Settings screen 83 and 84 as follows:
A “Play-To” score screen 85, defaults to a game generally played to 11 points but offering other options;
A “Win-By” value screen 86, allows typically one or two points.

With a Win-By value of one, the first team to reach the Play-To score wins the game, at other values, a team wins by reaching the Play-To score but must win by the number of points selected as the Win-By value. This eliminates the case of a tie score.

An option to play to a high-number score, such as to a score of 99, is included and is used in cases where a referee or drill manager indicates to play for a given number of minutes and at the end of that time the higher score wins or, if tied, the next point wins. Games will not likely reach a score of 99 so the winner is determined by the referee stopping the game at the predetermined time and observing each team's score.

Once the scoring values are set and accepted, a Choose Player Screen 87 and 88 is presented to select which player the user of the device is according to the following definition:
Player A1—the first server of the game
Player A2—the first server's team mate
Player B1—the first receiver of serve of the game
Player B2—the first receiver's team mate

Upon entry, the scoring device presents the Play Screen 89 and 90 which displays a graphical representation of the court with each player in proper position. The user wearing the scoring device is displayed as “ME” on the court 91, while the others are displayed with their ‘A’ or ‘B’ designators. The players could be represented by names or initials if that data is input during setup and/or a built-in microphone may allow voice recording of a name for each player.

Alternative setup options may be used with the scoring device of the invention. For example, a series of screen rotation options 92 for those who prefer to wear the device on the other wrist or on the inside of the wrist. Color scheme selections 93, a default colorful scheme is offered but other colors or higher contrast monochrome schemes may be offered for outdoor play in sunlight. A setup for wireless communication between devices worn by other players in the same game or to a larger display screen or remote computer. The option to use the scoring device for other sports with their respective courts or play-field images, e.g. tennis, softball, golf, etc. Text entry of names or initials for players instead of the ‘A’ or ‘B’ designators and/or or voice recording of player names for later playback. The setting of an internal Real Time Clock used to date and timestamp game scores if they are stored or transmitted to a remote computer, or to display the current date and time for informational purposes. Other options are possible with the scoring device that make the device more useful or efficient.

In an exemplary aspect, the display of the court on the screen 90 is a representation of the court shown from the wearer's point of view. That is, the player “ME” is always shown on the lower half of the court 91 and the opposing team on the upper half. The view of the court on the wrist is then identical to that actually seen by the user.

When a button is pressed indicating which team has committed a fault, it may result in a point being scored or a change of server, the correct server's court quadrant is briefly flashed in contrasting color with an arrow indicating the quadrant of the court and player to receive the next serve. The server's quadrant remains displayed in a color contrasting or different from the rest of the court, clearly indicating at a glance which player is serving. After the button press, the built-in speaker may announce the name of the server and the current score. The button press may also initiate a wireless data communication to other players or to a remote location for game data display or gathering of statistics.

The generally accepted position of each player is shown before the next serve, including the court quadrant and whether the player is to be near the net or back at the baseline. For example, in Play Screen 92, “ME” is shown at the base line in the lower left quadrant of the court and partner A2 at the base line of the lower right quadrant. After Team A commits a fault, the Play Screen 93 is updated to show “ME” in the same quadrant but at the net and partner A2 remains at the base line.

The score for each team is displayed in larger numbers on that team's side of the net as depicted on Play Screen 92 as items 94 and 95. According to game rules, before each serve the serving player is required to call out the score along with whether the player is the first or second server to serve on that team. This score is defined herein as the ‘callout score.’ It consists of the serving team's score, followed by the receiving team's score, and then either “One” or “Two”. To make it easier to remember, the display screen will show the callout score in the area of the court where the net would normally be as depicted on Play Screen 93 as item 96. The order of these scores and the “One” or “Two” are correctly represented based on which team and which player on that team is serving, e.g. 3-4-2, or 8-9-1, etc. An optional feature can be considered whereby the ‘call-out’ score is announced over the built-in speaker. This announcement may only occur if the player is currently the active server which is required to call out the score, reminding the player of the score before serving.

A text information line 97 may be presented on the Play Screen below the depiction of the court. This line may generally include a game timer which begins when the final options are set and the court image is displayed and continues timing until a winner is declared based on the Play-To and Win-By values. This line may also be used to periodically indicate if the internal battery is low on charge, as well as other pertinent information. For example, if each player's device is connected to the other players, this line may indicate that three of the four players are receivers of the data from a master worn by a first player or that communication has been lost with a remote device if so configured.

In its preferred embodiment, the buttons surrounding the screen are considered ‘soft’ buttons and their function determined by the mode of operation of the device (setup or play or other mode). The definitions may be displayed with text but appropriate more international icons can be employed to reduce screen clutter and appeal to those speaking other languages. In one embodiment, these icons may be as follows:

[symbol] indicates fault has been committed by a team

[symbol] indicates SETTINGS or OPTIONS

[symbol] indicates UNDO if an incorrect button is pressed during play

[symbol] indicates to begin a NEW GAME, possibly abandon the current game

[symbol] indicates to ACCEPT the current option or settings

[symbol] indicates to CANCEL the current option or settings

The buttons surrounding the screen may be color coded and the corresponding screen icons displayed in the same color, or button and screen icon colors may be unrelated.

As the game progresses, one of the buttons defined on the Play Screen allows one or more layers of UNDO 98 and 99. If pressed, the display returns to the state prior to the last button press which is undone. A press of the NEW GAME button 100 and 101 will be met with a Confirmation Screen 102 and 103 if the current game is not complete. If confirmed the user is asked to accept or change the Play-To, Win-By, and player definition before staring the new game. If not confirmed (canceled) the current game resumes with no changes and the game timer continues.

When the conditions of winning have been met, the screen will clear the court area of all but the final call-out score and the Winner Screen 104 and 105 will display a large WIN! on the half of the court representing the team that won the game. The call-out score remains, as does the final time of the game timer for reference. An audio signal may also be played from the speaker. Once the NEW GAME 106 and 107 button is pressed, this information is discarded and the user is immediately directed through a new game setup procedure.

Although the game information may be discarded in a simple embodiment, it can be stored within the device or sent wirelessly to another device for the purposes of recording wins and losses and statistically analyzing the data. Over time, this data could be used, for example, to determine and update the user's skill rating or competitive ranking

An exemplary embodiment of the scoring device of the invention includes the following components or functional blocks. A housing worn on the wrist or a lanyard by the player. It may be water resistant or water proof. When worn on the wrist the band may be a flexible silicone type similar to popular smart watches, hook-and-loop type or when worn around the player's neck, shoulder, or torso it may attach with a lanyard. A display screen contained in the housing, preferably a square or rectangular color dot matrix screen although a round display can also be used. In a preferred embodiment this screen is at least 128 pixels×128 pixels, is approximately 1.5 inches in diagonal measure, and may be an RGB OLED screen for small size, weight, and power consumption. A touchscreen may also be incorporate over the top of the display screen and operably connected to the microprocessor. A plurality of pushbuttons with a positive ‘click’ surrounding the screen and contained in the housing in such a way that their useful definition can be indicated with an icon on the screen near each button. For indicating a game fault during play, a touchscreen may invite unintentional touches that are likely to cause confusing results, whereas one or more buttons used for this purpose require an intentional press and ‘click’, possibly with audio or haptic feedback, reducing the possibility for unintentional data input.

The scoring device of the invention also includes the following further components or functional blocks. An externally accessible USB port or other charging port, contained in the housing for charging an internal power source, uploading software changes, or downloading stored accumulated data. This port may have an elastomeric cover or plug to improve water resistance. Charging may also be accomplished wirelessly and software updates may also be wireless. A battery power source internal to the housing of sufficient capacity to operate the electronic components of device through at least several typical games. A preferred Lithium Polymer battery has good capacity to size ratio, an appropriate output voltage and is rechargeable via the USB port. A power on/off switch to turn the device on or off, conserving power when not in use but still allowing charging of an internal battery when off. It may be a ‘soft’ power switch where the invention automatically turns off after a period of non-use and, as an example, the power button or any button press may return power. A microprocessor with integral non-volatile and volatile memory capable of operating the device including the RGB display, buttons, timers, clock, USB port, audio and haptic feedback features, wireless components, and containing the software algorithms to operate the device according to the rules of the sport to be played. A charging circuit to manage battery charging via the USB port and the discharging of the battery providing indication of the state of the battery for display on the screen. An optional wireless communication circuit to allow data communication between devices and players or to remote devices for display or analysis of the data. A microphone and speaker to record player names, announce the server name during play, announce the score and audibly signal the user of a WIN! condition, low battery condition, or other important information.

As explained above, the use of one or two buttons with click/haptic/audio feedback make use of the scoring device during the game easy, even if not looking at the display screen. Additionally, the algorithm requiring the player to know only which team committed the fault to manage and present all the other game data make the scoring device unique, efficient, and effective.

Those skilled in the art will understand that the physical housing and electronic components described herein may be designed for a streamlined look as well as a smaller size making it aesthetically appealing, unobtrusive during game play, and lightweight.

Those skilled in the art, having knowledge gained from the present disclosure, will recognize that various changes could be made in these processes and systems, without departing from the scope of the present invention. While in the foregoing specification the invention has been described in relation to certain preferred embodiments thereof, and details have been set forth for purpose of illustration, it will be apparent to those skilled in the art that the disclosure is susceptible to additional embodiments, based on modification, alteration, changes or substitution of various features described herein, without departing significantly from the spirit of the disclosure. For example, the dimensions, number, size and shape of the various components may be altered to fit specific applications. Accordingly, the specific embodiments illustrated and described herein are for illustrative purposes only, and not limiting of the invention.

What is claimed is:

1. A personal scoring device worn by a player for scoring the game of pickleball, the device comprising:
a housing,
a display module having a display and operatively connected to a microprocessor, the display module and microprocessor contained within the housing,
a graphical representation of the pickleball playing court presented on the display, wherein the recommended position of each player is shown on the playing court, and the current server and each team's score is displayed on the display,
a rechargeable battery that may be charged by a charging circuit that is connected to the microprocessor,
at least one user input button operatively connected to the microprocessor to receive user input to indicate a game fault committed by either a first team or a second team, and
wherein when the player presses the at least one user input button at least once the device records a fault committed by either the first team or the second team, and
wherein when the player presses the at least one user input button, the microprocessor controlled by a software algorithm automatically updates all game parameters including each team's score, which team is serving, and which player is serving.

2. The personal scoring device of claim 1, further comprising a touchscreen incorporated over the display module.

3. The personal scoring device of claim 1, further comprising wireless communication circuitry operatively connected to the microprocessor to allow wireless data transmission from the device.

4. The personal scoring device of claim 1, further comprising a microphone and speaker operatively connected to the microprocessor.

5. The personal scoring device of claim 1, wherein when the player presses the at least one user input button once the device records a fault committed by the first team, and when the player presses the at least one user input button twice the device records a fault committed by the second team.

6. The personal scoring device of claim 1, wherein the at least one user input button is a first user input button and a second user input button, wherein the first user input button receives user input to indicate a game fault committed by a first team, and wherein the second user input button receives user input to indicate a game fault committed by a second team.

7. The personal scoring device of claim 6, wherein when the player presses the first user input button the device records a fault committed by the first team, wherein when the player presses the second user input button the device records a fault committed by the second team, and wherein when the player presses either the first or second user input button, the microprocessor controlled by a software algorithm automatically updates all game parameters including each team's score, which team is serving, and which player is serving.

8. The personal scoring device of claim 1, further comprising a wrist-band coupled to the housing to permit the personal scoring device to be worn on the player's wrist.

9. The personal scoring device of claim 1, further comprising a haptic device operatively coupled to the at least one user input button, the haptic device providing a vibration upon the pressing of the at least one user input button to provide feedback to the player so that the player does not need to look at the display to confirm that the game parameters have been updated.

10. The personal scoring device of claim 1, wherein when the conditions of winning the pickleball game are met, the microprocessor indicates the winning team on the display.

11. The personal scoring device of claim 1, further comprising a microphone for receiving the names of the players, and a speaker that provides a digitized audio output that announces the score and which player is to serve the ball.

12. A method of scoring the game of pickleball comprising the steps of:
providing a personal scoring device that may be worn by a player and that comprises a housing, a display module having a display that shows at least a pickleball court, the player's positions on the court and the score, the display module operatively connected to a microprocessor, a software algorithm that controls the operation of the microprocessor, at least one user input button operatively connected to the microprocessor to receive user input to indicate a game fault committed by either a first team or a second team, and
receiving the player's input after the player presses the at least one user input button that indicates a fault by the first team,
receiving the player's input after the player presses the at least one user input button that indicates a fault by the second team,
processing the player's input via the microprocessor controlled by the software algorithm to automatically update all game parameters including each team's score, which team is serving, and which player is serving,
as the game progresses, presenting graphically on the graphic display the game score, the server position and the recommended player positions on the court, and
signaling the game winner by the microprocessor when the conditions of winning the pickleball game are met.

13. The method of claim 12, wherein the signaling of the game winner is done audibly through a speaker operatively coupled to the microprocessor or done graphically on the display or both.

14. The method of claim 12, wherein the personal scoring device further includes a microphone for receiving the names of the players, and includes a speaker that provides a digitized audio output that announces the score and which player is to serve the ball.

15. The method of claim 12, wherein when the player presses the at least one user input button once the device records a fault committed by the first team, and when the player presses the at least one user input button twice the device records a fault committed by the second team.

16. The method of claim 12, wherein the at least one user input button is a first user input button and a second user input button, wherein the first user input button receives user input to indicate a game fault committed by a first team, and wherein the second user input button receives user input to indicate a game fault committed by a second team.

17. The method of claim 16, wherein when the player presses the first user input button the device records a fault committed by the first team, wherein when the player presses the second user input button the device records a fault committed by the second team, and wherein when the player presses either the first or second user input button, the method further comprising the step of the software algorithm automatically updating all game parameters including each team's score, which team is serving, and which player is serving.

18. The method of claim 12, further comprising the step of clearing the display of the game information except for the final score, the half of the court representing the team that won the game and the final time on a game timer.

19. The method of claim 12, wherein the personal scoring device further includes a haptic device operatively coupled to the at least one user input button, and further comprising the step of providing a vibration from the haptic device to the player upon the pressing of the at least one user input button to provide feedback to the player without the player needing to look at the display.

20. The method of claim 12, wherein the personal scoring device further includes a wireless communication circuit operatively coupled to the microprocessor, the method further comprising the step of wirelessly transmitting data from the device.
